(19) United States
(12) Patent Application Publication
(10) Pub. No.: US 2007/0215286 A1
(43) Pub. Date: Sep. 20, 2007

(54) Apparatus for manufacturing corrugated sheet

(75) Inventor: Teruhisa Kaneda, Yokohama-shi (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/723,022

(22) Filed: Mar. 15, 2007

(30) Foreign Application Priority Data
Mar. 16, 2006 (JP) 2006-072745

(51) Int. Cl. B32B 37/00

(52) U.S. Cl. 156/360; 156/472

(57) ABSTRACT

A corrugated sheet manufacturing apparatus includes: a forming roll pair configured to roll a band material into a first-shape corrugated sheet; a pitch-shortening roll pair configured to shorten pitches of the first-shape corrugated sheet into a second-shape corrugated sheet; a shaping roll pair configured to widen pitches of the second-shape corrugated sheet into an objective corrugated sheet; a distance changer configured to change an axis-to-axis distance of the forming roll pair; a detector configured to detect a quantity of the first-shape corrugated sheet delivered from the forming roll pair; and a controller configured to control, when the detected quantity of the first-shape corrugated sheet is equal to a predetermined value, the distance changer so that the axis-to-axis distance of the forming roll pair is changed from a first distance to a second distance that is larger than the first distance.

### CROSS REFERENCE TO RELATED APPLICATIONS AND INCORPORATION BY REFERENCE

This application is based upon and claims the benefit of priority from the prior Japanese Patent Application No. 2006-072745 filed on Mar. 16, 2006, the entire contents of which are incorporated herein by reference.

### BACKGROUND OF THE INVENTION

1. Field of the Invention

The present invention generally relates to a corrugated sheet used for a metal carrier that purifies exhaust gas discharged from an internal combustion engine of, for example, a vehicle. In particular, the present invention relates to an apparatus for manufacturing a corrugated sheet having a part where the height of corrugations gradually decreases.

2. Description of Related Art

A vehicle having an internal combustion engine employs a metal carrier serving as a catalytic converter for removing noxious components from exhaust gas. The metal carrier is manufactured by coiling a corrugated sheet with a flat sheet into a metallic honeycomb core having a honeycomb sectional shape and by inserting the metallic honeycomb core into a metallic cylinder.

When forming the metallic honeycomb core (sometimes referred to simply as “core”), a related art disclosed in Japanese Unexamined Patent Application Publication No. 9-300031 lays leading ends of corrugated sheet and flat sheet one on another, sets them between winding shafts, and turns the winding shafts to roll up the overlapped corrugated and flat sheets into a spiral shape.

### SUMMARY OF THE INVENTION

The manufacturing method of the above-mentioned related art causes a step-like difference at a spiral end of the core due to the thickness of the overlapped corrugated and flat sheets. When the core is forcibly inserted into a metallic cylinder, the step-like difference causes a local deformation that may be propagated toward the center of the core, to make an internal shape of the core deviate from a designed shape. The improper internal shape of the core increases excessive catalytic fillets during a catalytic coating process. Such excessive catalytic fillets increase air-flow resistance.

The improper internal shape and excessive catalytic fillets of the core cause another problem of reducing a volumetric surface area of the corrugated sheet that contacts exhaust gas.

These problems become more serious when increasing the height (amplitude) of corrugations of the corrugated sheet in an attempt to reduce air-flow resistance and increase a purifying ability.

An object of the present invention is to provide an apparatus for manufacturing a corrugated sheet that is appropriate for reducing a step-like difference that may be caused at a winding end when the corrugated sheet is rolled up with a flat sheet into a honeycomb core.

A first aspect of the present invention provides an apparatus for manufacturing a corrugated sheet. The corrugated sheet manufacturing apparatus includes: a forming roll pair configured to roll a band material into a first-shape corrugated sheet; a pitch-shortening roll pair configured to shorten pitches of the first-shape corrugated sheet into a second-shape corrugated sheet; a shaping roll pair configured to widen pitches of the second-shape corrugated sheet into an objective corrugated sheet; a distance changer configured to change an axis-to-axis distance of the forming roll pair; a detector configured to detect a quantity of the first-shape corrugated sheet delivered from the forming roll pair; and a controller configured to control, when the detected quantity of the first-shape corrugated sheet is equal to a predetermined value, the distance changer so that the axis-to-axis distance of the forming roll pair is changed from a first distance to a second distance that is larger than the first distance.

A second aspect of the present invention provides an apparatus for manufacturing a corrugated sheet. The corrugated sheet manufacturing apparatus includes: a forming roll pair configured to form a band material into a first-shape corrugated sheet; a pitch-shortening roll pair configured to shorten pitches of the first-shape corrugated sheet into an intermediate-shape corrugated sheet with adjacent ridges of the intermediate-shape corrugated sheet being in contact with each other, and then, separate the adjacent ridges of the intermediate-shape corrugated sheet from each other into a second-shape corrugated sheet whose pitches are wider than those of the intermediate-shape corrugated sheet; a shaping roll pair configured to widen each pitch between the adjacent ridges of the second-shape corrugated sheet into an objective corrugated sheet; a distance changer configured to change an axis-to-axis distance of the forming roll pair; a detector configured to detect a quantity of the first-shape corrugated sheet delivered from the forming roll pair; and a controller configured to control, when the detected quantity of the first-shape corrugated sheet is equal to a predetermined value, the distance changer so that the axis-to-axis distance of the forming roll pair is changed from a first distance to a second distance that is larger than the first distance.

### BRIEF DESCRIPTION OF THE DRAWINGS

FIG. 1A is a sectional view showing forming rolls of an apparatus for manufacturing a corrugated sheet according to an embodiment of the present invention, an axis-to-axis distance of the forming rolls being set at a reference first distance;

FIG. 1B is a sectional view showing the forming rolls of FIG. 1A, the axis-to-axis distance being set at a second distance that is larger than the first distance;

FIG. 2 is a partly sectioned perspective view showing the forming rolls of FIG. 1A;

FIG. 3 is a view showing roll pairs installed in the apparatus according to the embodiment;

FIG. 4 is an enlarged view partly showing the forming rolls among the roll pairs of FIG. 3;

FIG. 5 is an enlarged view partly showing pitch-shortening rolls among the roll pairs of FIG. 3;

FIG. 6 is an enlarged view partly showing shaping rolls among the roll pairs of FIG. 3;

FIG. 7 is an enlarged view showing an entrance of the pitch-shortening rolls of FIG. 5;

FIG. 8 is an explanatory view showing a corrugated sheet delivered from the pitch-shortening rolls of FIG. 5;

FIG. 9 is a perspective view showing a metal carrier employing a corrugated sheet manufactured by the apparatus according to the embodiment;

FIG. 10 is a front view showing a metal carrier employing a corrugated sheet manufactured by the apparatus according to the embodiment; and

FIG. 11 is a front view showing a metal carrier employing a corrugated sheet manufactured according to a related art.

### DETAILED DESCRIPTION OF EMBODIMENTS

An apparatus for manufacturing a corrugated sheet according to an embodiment of the present invention will be explained.

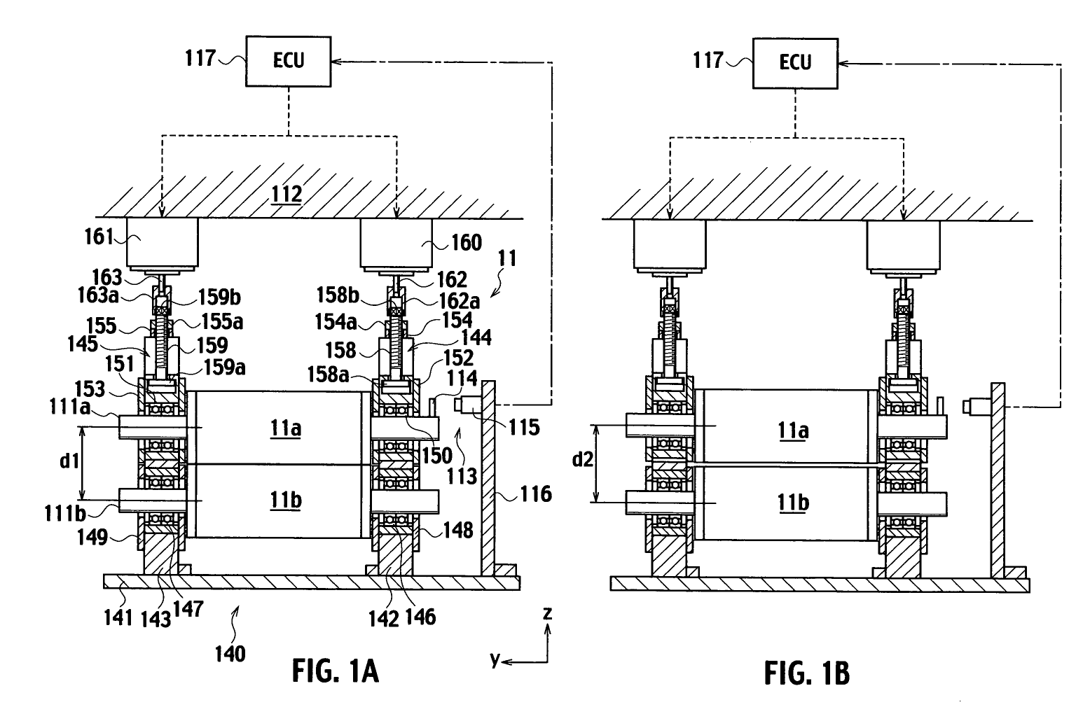

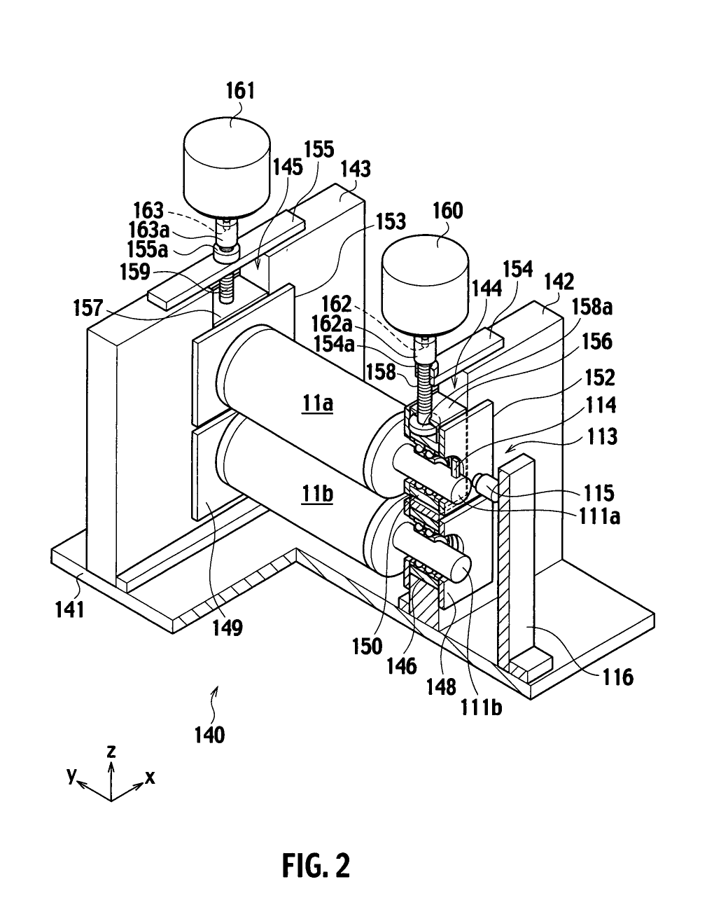

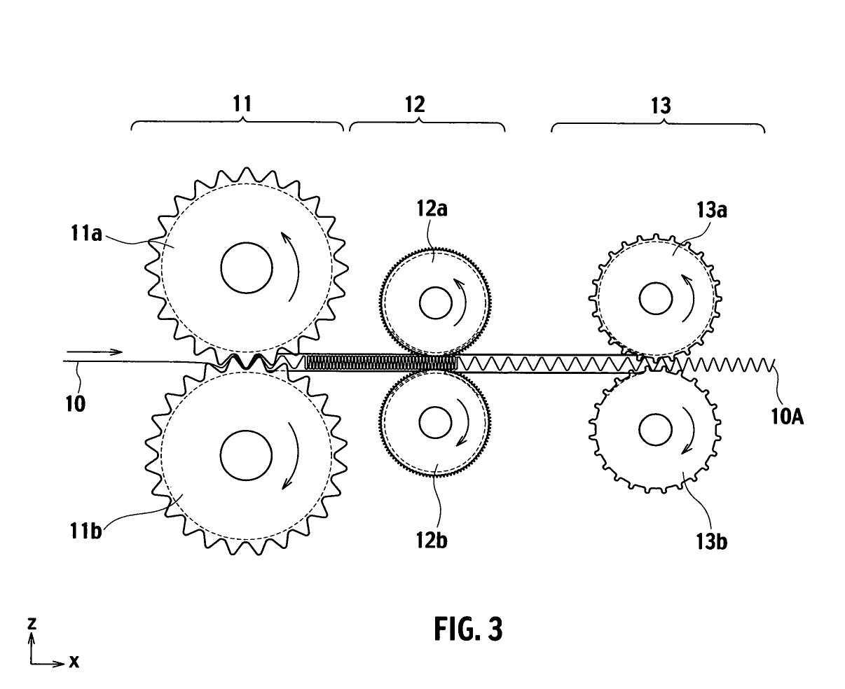

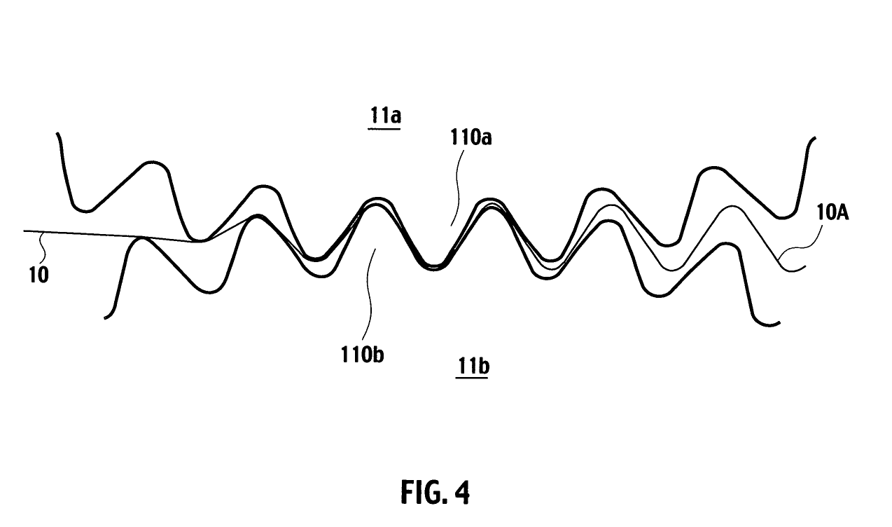

FIGS. 1A and 1B are sectional views showing forming rolls of the apparatus, FIG. 2 is a partly sectioned perspective view showing the forming rolls, FIG. 3 is a view generally showing roll pairs installed in the apparatus, and FIGS. 4 to 6 are enlarged views partly showing the roll pairs.

A general structure of the corrugated sheet manufacturing apparatus 100 will be explained with reference to FIGS. 3 to 5. In FIG. 3, the apparatus 100 includes a forming roll unit 11, a pitch-shortening roll unit 12, and a shaping roll unit 13.

On the upstream side of the forming roll unit 11, there is a supply roll (not shown) around which a band material 10 is wound. The band material 10 is drawn from the supply roll by a feed roll (not shown) and is continuously fed to the forming roll unit 11. In FIG. 3, mechanisms for supporting and driving rolls are omitted.

The forming roll unit 11 includes a pair of forming rolls 11a and 11b that are vertically arranged and synchronously turned. The surface of the forming roll 11a (11b) has forming teeth 110a (110b) as shown in FIG. 4. The teeth 110a and 110b engage with each other with a gap between them, and the forming rolls 11a and 11b are turned in an arrow direction (FIG. 3) while the band material 10 is being fed between the teeth 110a and 110b, to form the band material 10 into a corrugated sheet 10A having a first waveshape shown in FIG. 4. Not to break the band material 10 during the formation, the teeth 110a and 110b have a height (amplitude) lower than a target height and a pitch (wavelength) wider than a target pitch.

In FIG. 4, the forming roll 11a is at a reference position with the teeth 110a and 110b meshing each other at a reference first axis-to-axis distance d1.

The forming roll unit 11 is supported with a forming roll support 140 having a distance adjusting mechanism that adjusts the axis-to-axis distance of the forming rolls 11a and 11b.

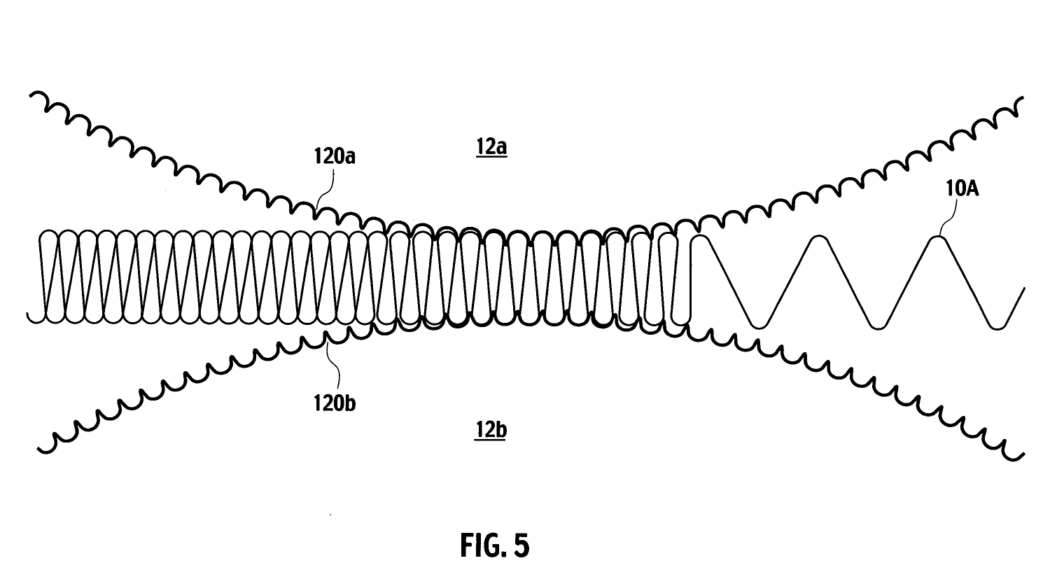

The pitch-shortening roll unit 12 includes pitch-shortening rolls 12a and 12b that are vertically arranged and synchronously turned. The surface of the roll 12a (12b) has forming teeth 120a (120b) as shown in FIG. 5. The corrugated sheet 10A fed from the upstream forming roll unit 11 is temporarily stopped at the entrance of the pitch-shortening roll unit 12, and therefore, adjacent ridges of the corrugated sheet 10A are made in contact with each other to form an intermediate waveshape. In the intermediate waveshape, each ridge of the corrugated sheet 10A is semicircular. Thereafter, the pitch-shortening rolls 12a and 12b are turned in an arrow direction (FIG. 3), so that ridges of the forming teeth 120a and 120b enter between the adjacent ridges of the corrugated sheet 10A. At this time, each valley of the teeth 120a and 120b entirely holds a corresponding ridge of the corrugated sheet 10A and separates the adjacent ridges of the corrugated sheet 10A from each other. At the exit of the pitch-shortening roll unit 12, the corrugated sheet 10A with separated ridges has a second waveshape whose pitches are wider than those of the intermediate waveshape.

If the ridges of the corrugated sheet 10A are partially held with the forming teeth 120a and 120b of the pitch-shortening rolls 12a and 12b, the corrugated sheet 10A will be deformed. According to the embodiment, the ridges of the corrugated sheet 10A are entirely held with the valleys of the teeth 120a and 120b as shown in FIG. 5, and therefore, the corrugated sheet 10A will not deform.

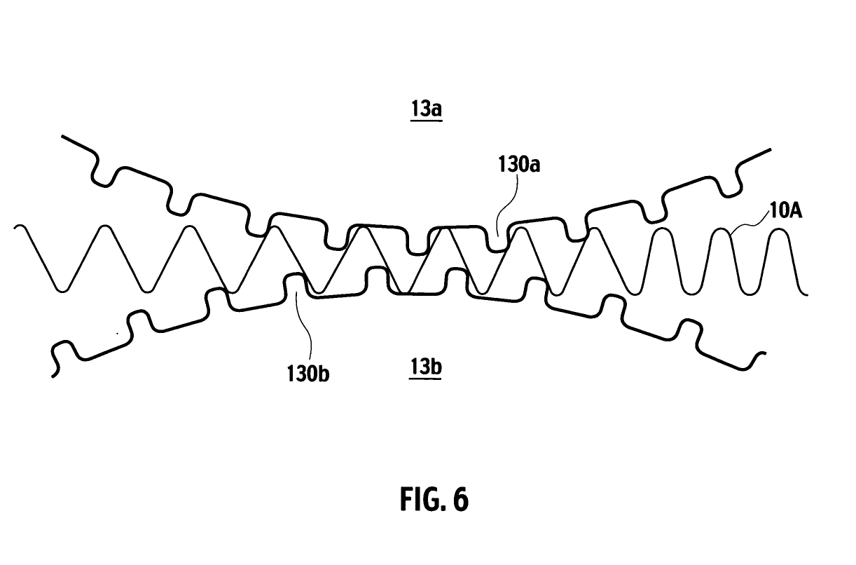

The shaping roll unit 13 includes shaping rolls 13a and 13b that are vertically arranged and synchronously turned. The surface of the shaping roll 13a (13b) has shaping teeth 130a (130b) as shown in FIG. 6. Ridges of the shaping teeth 130a and 130b enter between adjacent ridges of the corrugated sheet 10A having the second waveshape and stretches the corrugated sheet 10A, to widen the pitches of the corrugated sheet 10A. In consideration of resilience of the corrugated sheet 10A, the shaping roll unit 13 is set to stretch the corrugated sheet 10A so that the corrugated sheet 10A may have pitches that are wider than target pitches. When the corrugated sheet 10A is discharged from the shaping roll unit 13, the widened pitches thereof become shorter due to the resilience thereof, to have a target waveshape.

Between the forming roll unit 11 and the pitch-shortening roll unit 12 and between the pitch-shortening roll unit 12 and the shaping roll unit 13, guides (not shown) are arranged to prevent the corrugated sheet 10A from obliquely traveling in thickness and width directions and to release the corrugated sheet 10A from the teeth 110a, 110b, 120a, 120b, 130a, and 130b.

A driving mechanism for the forming roll unit 11 will be explained with reference to FIGS. 1A, 1B, and 2.

The forming roll unit 11 includes the forming rolls 11a and 11b that are supported with the support 140.

The support 140 includes a base 141 and a pair of roll stands 142 and 143 that are arranged on the base 141 at a predetermined interval. The roll stand 142 (143) has a stand recess 144 (145) into which the forming rolls 11a and 11b are vertically inserted.

The forming roll 11b has a roll shaft 111b whose protruding ends are supported with bearing units 146 and 147, respectively. The bearing unit 146 (147) is arranged in a bearing frame 148 (149). The bearing frame 148 (149) is arranged in the stand recess 144 (145). The position of the forming roll 11b is fixed.

The forming roll 11a has a roll shaft 111a whose protruding ends are supported with bearing units 150 and 151, respectively. The bearing unit 150 (151) is arranged in a bearing frame 152 (153). The bearing frame 152 (153) is arranged in the stand recess 144 (145). The forming roll 11a is movable by motors (to be explained later) in a vertical direction.

At the top of the roll stand 142 (143), the stand recess 144 (145) is covered with a shaft support plate 154 (155). At the center of the shaft support plate 154 (155), there is a through hole provided with a nut 154a (155a). The nut 154a (155a) engages with a thread of a drive shaft 158 (159) connected to the motor.

On the bearing frame 152 (153), there is a bearing box 156 (157). The bearing box 156 (157) engages with a pull disk 158a (159a) arranged at an end of the drive shaft 158 (159). The pull disk 158a (159a) is rotatable with respect to the drive shaft 158 (159). Accordingly, when the drive shaft 158 (159) is turned, the pull disk 158a (159a) does not turn together with the drive shaft. Instead, the pull disk 158a (159a) ascends or descends together with the bearing box 156 (157).

The axis-to-axis distance of the forming rolls 11a and 11b is changeable by the motors 160 and 161. In FIG. 1, the motors 160 and 161 are fixed to a top support 112. The motor 160 (161) has a motor shaft 162 (163) whose end is provided with a female coupling 162a (163a). The female coupling 162a (163a) has an internal long hole of quadrangle cross section engaging with a protrusion 158b (159b) having a similar quadrangle cross section formed at the top of the drive shaft 158 (159).

The motors 160 and 161 are driven under the control of a controller (ECU) 117. When the motor shaft 162 (163) is turned, torque is transmitted to the protrusion 158b (159b) engaging with the female coupling 162a (163a) of the drive shaft 158 (159), to turn the drive shaft 158 (159).

When the drive shaft 158 (159) is turned in a clockwise direction, the drive shaft 158 (159) engaging with the nut 154a (155a) moves downwardly, so that the pull disk 158a (159a) at the end of the drive shaft 158 (159) gradually descends together with the bearing frame 152 (153) to narrow the axis-to-axis distance of the forming rolls 11a and 11b.

When the drive shaft 158 (159) is turned in a counterclockwise direction, the drive shaft 158 (159) engaging with the nut 154a (155a) moves upwardly, so that the pull disk 158a (159a) at the end of the drive shaft 158 (159) gradually ascends together with the bearing frame 152 (153) to widen the axis-to-axis distance of the forming rolls 11a and 11b up to a second axis-to-axis distance d2.

A control mechanism for the forming roll unit 11 will be explained.

The forming roll 11a according to the embodiment has an encoder 113 for detecting the number of turns of the roll shaft 11a. The encoder 113 includes a pin 114 arranged at an end of the roll shaft 111a, a photodetector 115 attached to a stand 116, and a light source (not shown) arranged at a position facing the photodetector 115 with the pin 114 between the light source and the photodetector 115. When the roll shaft 111a rotates, light from the light source is periodically blocked by the pin 114 that rotates with the roll shaft 111a. As a result, the photodetector 115 generates a pulse representative of 0 or 1 during a period in which the light is blocked. The pulse is sent as an electric signal to the ECU 117. According to the embodiment, the number of turns of the forming roll 11a is used to detect a quantity of the corrugated sheet 10A discharged from the forming rolls 11a and 11b.

The ECU 117 may be a microcomputer including, for example, a central processing unit (CPU), a random access memory (RAM), a read-only memory (ROM), and an input/output (I/O) interface. The ECU 117 may be made of a plurality of microcomputers. The ECU 117 may be configured to control a variety of tasks in addition to the task of changing the axis-to-axis distance of the forming roll unit 11.

According to the embodiment, the ECU 117 finds the number of turns of the forming rolls 11a and 11b from an electric signal provided by the encoder 113. If the number of turns is equal to a predetermined number r1, the ECU 117 drives the motors 160 and 161 to turn the drive shafts 162 and 163 in a counterclockwise direction, thereby gradually lifting the bearing frames 152 and 153 until the axis-to-axis distance of the forming rolls 11a and 11b changes from the reference first distance d1 to the second distance d2 that is larger than the distance d1.

When the number of turns of the forming rolls 11a and 11b reaches a predetermined number r2, the ECU 117 drives the motors 160 and 161 to turn the drive shafts 162 and 163 in a clockwise direction, thereby gradually lowering the bearing frames 152 and 153 until the axis-to-axis distance of the forming rolls 11a and 11b becomes the first distance d1.

A sequence of manufacturing a corrugated sheet with the above-mentioned apparatus 100 will be explained.

The motors 160 and 161 are driven to lift the forming roll 11a from the reference position, and a flat band material 10 is passed through the forming roll unit 11 and pitch-shortening roll unit 12 up to the vicinity of the entrance of the shaping roll unit 13. Then, the motors 160 and 161 are driven to lower the forming roll 11a until the axis-to-axis distance of the forming rolls 11a and 11b becomes the first distance d1. Thereafter, the forming rolls 11a and 11b are driven in the arrow direction shown in Fig. FIG. 3. As a result, the band material 10 is formed into a corrugated sheet 10A having a first waveshape as shown in FIG. 4. This is a first forming process. At this time, the pitch-shortening roll unit 12 and shaping roll unit 13 are stopped.

The corrugated sheet 10A having the first waveshape reaches the pitch-shortening roll unit 12 and is blocked between the pitch-shortening rolls 12a and 12b. The forming rolls 11a and 11b are continuously driven, so that the corrugated sheet 10A having the first waveshape is temporarily stopped at the entrance of the pitch-shortening roll unit 12 and adjacent ridges of the first waveshape are pressed to each other to form an intermediate waveshape. This is a pitch-shortening process. At this time, the pitch-shortening rolls 12a and 12b may be turned in the arrow direction (FIG. 3) by a predetermined angle, so that the teeth 120a and 120b of the rolls 12a and 12b may engage with ridges of the intermediate waveshape.

The forming rolls 11a and 11b are continuously driven, and the intermediate waveshape is formed between the forming roll unit 11 and the pitch-shortening roll unit 12. When the intermediate waveshape is formed to reach the exit of the forming roll unit 11, the forming roll unit 1, pitch-shortening roll unit 12, and shaping roll unit 13 are synchronously driven to deliver the corrugated sheet 10A ridge by ridge toward the downstream side. After starting the synchronous driving, there is no need of temporarily stopping the corrugated sheet 10A between the forming roll unit 11 and the pitch-shortening roll unit 12. Ridges of the first waveshape discharged from the forming roll unit 11 are sequentially brought close to each other between the forming roll unit 11 and the pitch-shortening roll unit 12 into ridges of the intermediate waveshape.

During the synchronous driving, ridges of the teeth 120a and 120b of the pitch-shortening rolls 12a and 12b enter between the ridges of the corrugated sheet 10A having the intermediate waveshape as shown in FIG. 5. At this time, valleys of the teeth 120a and 120b entirely hold the ridges of the corrugated sheet 10A and separate adjacent ridges of the corrugated sheet 10A from each other, to form a second waveshape whose pitches are wider than those of the intermediate waveshape. This is a second forming process.

The corrugated sheet 10A having the second waveshape is stretched by the teeth 130a and 130b of the shaping rolls 13a and 13b, to widen the pitches of the second waveshape as shown in FIG. 6. After delivered from the shaping roll unit 13, the widened pitches of the corrugated sheet 10A contract due to resilience to form an objective waveshape. This is a third forming process.

An operation of gradually lowering the height of corrugations of the corrugated sheet 10A during the formation of the corrugated sheet 10A will be explained.

In a normal state shown in FIG. 1A, the ECU 117 sets the forming roll 11a at a normal position where the axis-to-axis distance of the forming roll unit 11 is the first distance d1 to produce a corrugated sheet 10A having a normal height. The ECU 117 receives an electric signal from the encoder 113, and according to the electric signal, calculates the number of turns of the forming rolls 11a and 11b.

If the calculated number of turns is equal to a predetermined number r1, the ECU 117 drives the motors 160 and 161 in such a way as to turn the drive shafts 162 and 163 in a counterclockwise direction. Then, the bearing frames 152 and 153 gradually ascend until the axis-to-axis distance of the forming rolls 11a and 11b changes from the first distance d1 to the second distance d2 that is larger than the first distance d1.

Gradually widening the axis-to-axis distance between the forming rolls 11a and 11b up to the second distance d2 results in gradually shortening a corrugated length of the band material 10 and gradually reducing the height (amplitude) of corrugations of the corrugated sheet 10A.

Thereafter, if the number of turns of the forming rolls 11a and 11b becomes equal to a predetermined number r2, the ECU 117 drives the motors 160 and 161 in such a way as to turn the drive shafts 162 and 163 in a clockwise direction. As a result, the bearing frames 152 and 153 gradually descend until the axis-to-axis distance of the forming rolls 11a and 11b reaches the first distance d1.

Gradually reducing the axis-to-axis distance between the forming rolls 11a and 11b up to the first distance d1 results in gradually elongating a corrugated length of the band material 10 and gradually increasing the height of corrugations of the corrugated sheet 10A up to the normal height with which the corrugated sheet 10A is again stopped at the entrance of the pitch-shortening roll unit 12 to shorten the pitches of the corrugated sheet 10A.

Whenever the number of turns of the forming rolls 11a and 11b reaches the value r1 or r2, the above-mentioned operation is repeated to continuously produce the corrugated sheet 10A containing parts having different corrugation heights.

In this way, the embodiment gradually extends the axis-to-axis distance of the forming rolls 11a and 11b from the first distance d1 to the second distance d2, and thereafter, gradually reduces the axis-to-axis distance from the second distance d2 to the first distance d1, thereby forming a part in the corrugated sheet 10A where the height of corrugations of the corrugated sheet 10A gradually decreases from a standard height and then gradually increases to the standard height.

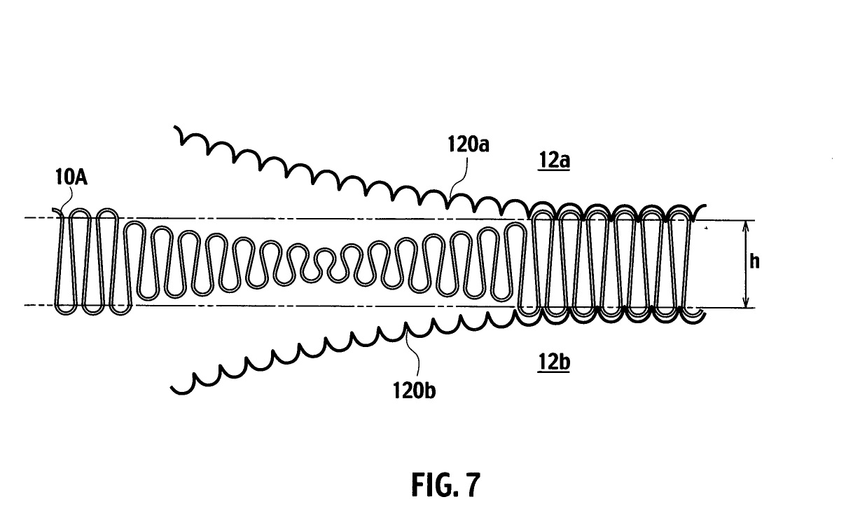

FIG. 7 is an enlarged view showing the entrance of the pitch-shortening roll unit 12. In particular, FIG. 7 shows a part of the corrugated sheet 10A where the height of corrugations gradually decreases from and increases to a normal height. A part of the corrugated sheet 10A having the normal corrugation height is caught by the teeth 120a and 120b of the pitch-shortening rolls 12a and 12b, and therefore, is pitch-shortened.

A part of the corrugated sheet 10A where the height of corrugations gradually decreases and becomes smaller than a gap h set between the teeth 120a and 120b is not caught by the teeth 120a and 120b of the rolls 12a and 12b. This part, thus, passes between the pitch-shortening rolls 12a and 12b without being pitch-shortened. In FIG. 7, the part where the height of corrugations gradually lowers and the part where the same gradually increases are depicted shorter than actual ones, for the sake of easy understanding.

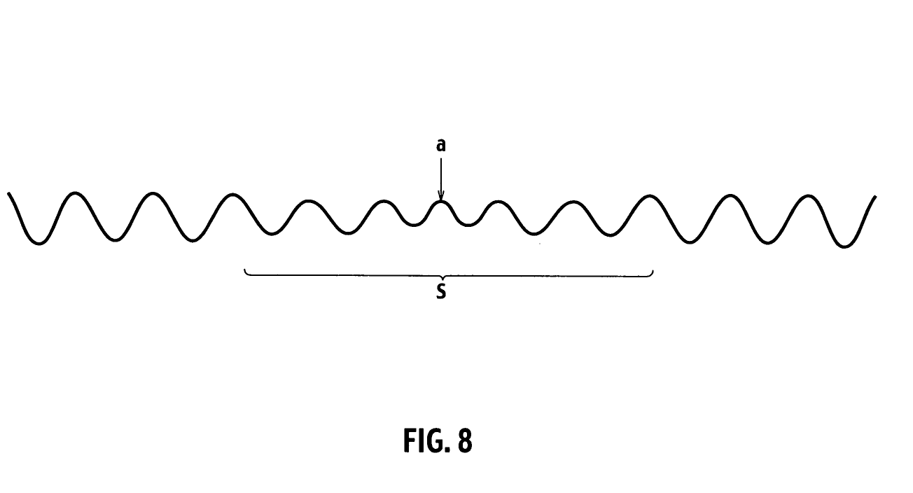

FIG. 8 shows the corrugated sheet 10A delivered from the pitch-shortening roll unit 12. In FIG. 8, “S” represents the part where the height of corrugations gradually lowers and increases.

The part S of the corrugated sheet 10A is also not caught by the teeth 130a and 130b of the shaping rolls 13a and 13b, and therefore, is passed as it is between the rolls 13a and 13b. The corrugated sheet 10A delivered from the shaping roll unit 13 is cut by a cutter (not shown) at a location “a” where the corrugation height of the corrugated sheet 10A is minimum.

The lowest corrugation height location “a” in the continuous corrugated sheet 10A can be identified according to the number of turns of the forming rolls 11a and 11b and a distance from the forming roll unit 11 to the cutter (not shown). The location “a” corresponds to a time when the number of turns of the forming rolls 11a and 11b becomes r2 to return the axis-to-axis distance of the forming rolls 11a and 11b to the first distance d1. From this time, the number of turns of the forming rolls 11a and 11b is counted to calculate a length of the corrugated sheet 10A discharged from the forming roll unit 11. When the calculated length of the corrugated sheet 10A becomes equal to the distance between the forming roll unit 11 and the cutter, the corrugated sheet 10A is cut by the cutter. By this, the corrugated sheet 10A can be cut at the location “a” where the corrugation height of the corrugated sheet 10A is lowest.

At a location distanced by a required length from the cut location, the corrugated sheet 10A is again cut, to provide a corrugated sheet product having an end part where the corrugation height of the product gradually decreases.

The apparatus according to the embodiment can continuously provide a corrugated sheet, and therefore, is helpful to realize a continuous manufacturing line. The corrugated sheet 10A produced by the apparatus of the embodiment contains a part where the corrugation height thereof gradually decreases and a part where the corrugation height thereof gradually increases. Such a corrugated sheet 10A is cut at a lowest height location “a” to simultaneously provide two corrugated sheet products with one end involving gradually attenuating corrugations. Accordingly, the embodiment can improve the yield of corrugated sheet products.

A metal carrier employing a corrugated sheet product manufactured according to the above-mentioned embodiment will be explained.

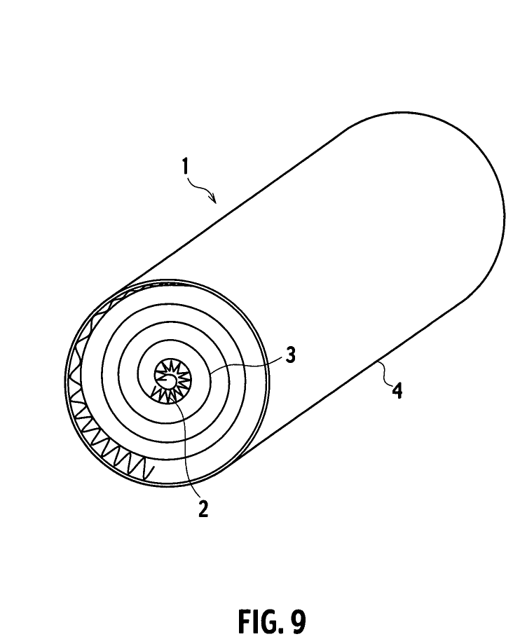

FIG. 9 is a perspective view showing a metal carrier according to an embodiment of the present invention. In FIG. 9, the metal carrier 1 has a core. The core is made of a corrugated sheet 2 (10A of the above-mentioned embodiment) made of a thin metal sheet spiraled with a flat sheet (or a corrugated sheet having small corrugations) 3. The core is covered with a soldering foil and is inserted into a metal cylinder 4. The cylinder 4 containing the core is heated in a vacuum, to diffuse and join the corrugated sheet 2 and flat sheet 3 with each other. At this time, the soldering foil joins with the cylinder 4, to form the metal carrier 1.

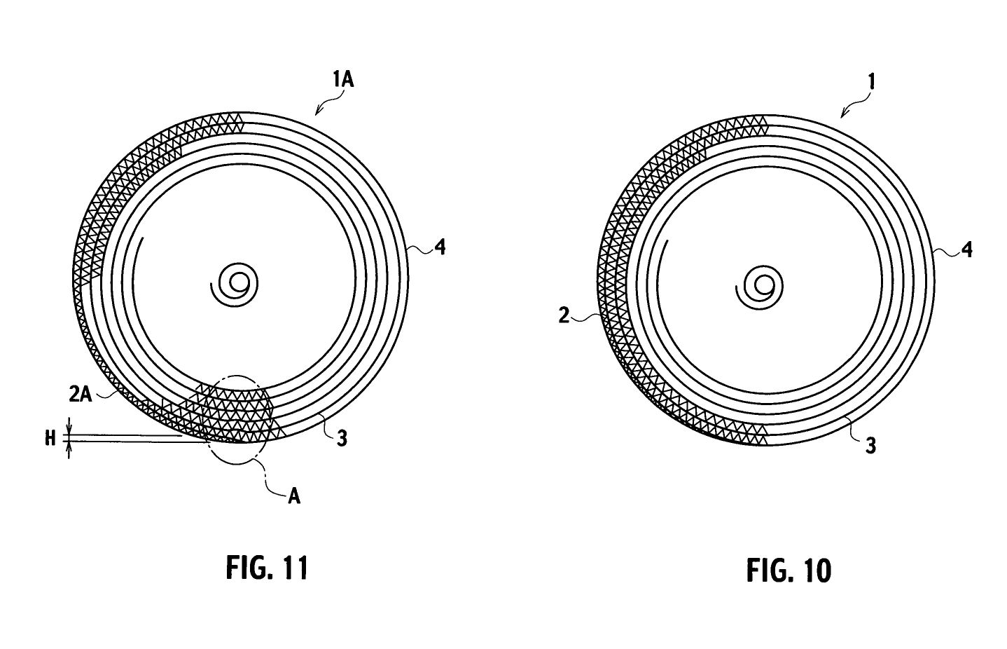

FIG. 10 is a front view showing a metal carrier 1 manufactured according to an embodiment of the present invention and FIG. 1 is a front view showing a metal carrier according to a related art.

According to the related art shown in FIG. 11, a corrugated sheet 2A is coiled with a flat sheet 3, to form a core. The core has a step-like difference H at a finishing end of the coiled sheets. The difference H corresponds to the height of corrugations of the corrugated sheet 2A. When the core is inserted into a cylinder 4, the difference H locally deforms the core in an area “A” shown in FIG. 11. On the other hand, according to the embodiment of FIG. 10, a corrugated sheet 2 coiled with a flat sheet 3 forms no step-like difference at a finishing end of the core because the height of corrugations at a trailing end of the corrugated sheet 2 gradually decreases. When the core is inserted into a cylinder 4, no local deformation occurs in the core, and therefore, an internal shape of the metal carrier has a designed shape. Namely, the metal core 1 manufactured according to the present invention with the core inserted into the cylinder 4 involves no deformation.

After coated with a catalyst, the metal carrier 1 according to the present invention has no excessive catalytic fillets, and therefore, achieves low air-flow resistance. Namely, the catalyst-coated corrugated sheet in the metal carrier 1 according to the present invention has a required surface area per unit volume, to achieve a designed purifying ability.

To improve a purifying ability, the height of corrugations of a corrugated sheet must be increased. Even with such higher corrugations, a corrugated sheet according to the present invention causes no increase in air-flow resistance or no decrease in a purifying ability. A metal carrier with a corrugated sheet having high corrugations according to an embodiment of the present invention can further improve a purifying ability compared with existing ones.

Although the present invention has been explained in connection with an embodiment of an apparatus for manufacturing a corrugated sheet used for a metal carrier having a honeycomb structure, the present invention is not limited to the embodiment. Various modifications will be possible on the embodiment without departing from the scope and spirit of the present invention. Each component of the embodiment apparatus is replaceable with any other component having an equivalent function. The corrugated sheet manufactured according to the present invention is applicable not only to metal carriers but also to any other products.

What is claimed is:

1. An apparatus for manufacturing a corrugated sheet, comprising:
a forming roll pair configured to roll a band material into a first-shape corrugated sheet;
a pitch-shortening roll pair configured to shorten pitches of the first-shape corrugated sheet into a second-shape corrugated sheet;
a shaping roll pair configured to widen pitches of the second-shape corrugated sheet into an objective corrugated sheet;
a distance changer configured to change an axis-to-axis distance of the forming roll pair;
a detector configured to detect a quantity of the first-shape corrugated sheet delivered from the forming roll pair; and
a controller configured to control, if the detected quantity of the first-shape corrugated sheet is equal to a predetermined value, the distance changer so that the axis-to-axis distance of the forming roll pair is changed from a first distance to a second distance that is larger than the first distance.

2. An apparatus for manufacturing a corrugated sheet, comprising:
a forming roll pair configured to form a band material into a first-shape corrugated sheet;
a pitch-shortening roll pair configured to shorten pitches of the first-shape corrugated sheet into an intermediate-shape corrugated sheet with adjacent ridges of the intermediate-shape corrugated sheet being in contact with each other, and then, separate the adjacent ridges of the intermediate-shape corrugated sheet from each other into a second-shape corrugated sheet whose pitches are wider than those of the intermediate-shape corrugated sheet;
a shaping roll pair configured to widen each pitch between the adjacent ridges of the second-shape corrugated sheet into an objective corrugated sheet;
a distance changer configured to change an axis-to-axis distance of the forming roll pair;
a detector configured to detect a quantity of the first-shape corrugated sheet delivered from the forming roll pair; and
a controller configured to control, if the detected quantity of the first-shape corrugated sheet is equal to a predetermined value, the distance changer so that the axis-to-axis distance of the forming roll pair is changed from a first distance to a second distance that is larger than the first distance.
